(19) United States
(12) Patent Application Publication
(10) Pub. No.: US 2025/0125416 A1
(43) Pub. Date: Apr. 17, 2025

(54) HIGH MOLECULAR WEIGHT FUNCTIONALIZED POLYMERS FOR ELECTROCHEMICAL CELLS

(71) Applicant: Ionic Materials, Inc., Woburn, MA (US)

(72) Inventors: Alexander Ali Ibrahim Mohamed, Medford, MA (US); Andrew Paul Leitner, Lynn, MA (US)

(73) Assignee: Ionic Materials, Inc., Woburn, MA (US)

(21) Appl. No.: 18/685,467

(22) PCT Filed: Sep. 27, 2022
(86) PCT No.: PCT/US2022/044841

§ 371 Date: Feb. 21, 2024

Related U.S. Application Data
(60) Provisional application No. 63/248,639, filed on Sep. 27, 2021.

(51) Int. Cl. H01M 10/0565; C08G 59/14; C08G 59/22; C08G 59/44; C08G 59/62; C08G 65/26; H01M 10/0525

(52) U.S. Cl. CPC H01M 10/0565; C08G 59/1477; C08G 59/22; C08G 59/44; C08G 59/62; C08G 65/2609; H01M 10/0525; H01M 2300/0082

(57) ABSTRACT

High molecular weight functionalized polymers (“high dielectric polymers”) are disclosed herein, along with related methods of use and manufacture. The high dielectric polymers have a relatively high dielectric permittivity (e.g., greater than 10) as well as a relatively low glass transition temperature (e.g., less than −30° C.). The polymers may be produced utilizing addition polymerization or anionic ring opening to yield a linear or branched polymer backbone containing numerous residual nucleophiles. Then, nucleophilic substitution may be carried out to functionalize the residual nucleophiles. The functionalized polymer may then be purified and used as polymer electrolyte in an electrochemical cell (e.g., as nonaqueous polymeric electrolyte in a secondary Li-ion battery), if desired.

### CROSS-REFERENCE TO RELATED APPLICATIONS

The present application claims priority to U.S. Provisional Patent Application Ser. No. 63/248,639 filed Sep. 27, 2021, the entire contents of which are herein incorporated by reference.

### FIELD

The subject disclosure relates to polymeric electrolytes, and more particularly, to high molecular weight functionalized polymers for electrochemical cells (e.g., lithium-ion batteries).

### BACKGROUND

A nonaqueous battery such as a lithium-ion battery is characterized by a high energy density and thus has been widely used as a power source for applications from small and portable devices. More recently, the energy density and reliability of such batteries has increased to a level that makes them viable for use in all electrified motor vehicles. In parallel with these developments, it is also important to ensure safety.

Modern Li-ion batteries typically consist of three components: (1) a positive electrode, (2) a negative electrode, and (3) an electrically insulating but ionically conductive interlayer (i.e., separator).

### SUMMARY

High molecular weight functionalized polymers are disclosed herein, along with related methods of use and manufacture. The presently disclosed high molecular weight functionalized polymers have a relatively high dielectric permittivity (e.g., greater than 10) as well as a relatively low glass transition temperature (e.g., less than −30° C.). These properties present unique advantages when the polymer is used as a polymer electrolyte in an electrochemical cell, such as a lithium-ion battery. For example, the high dielectric constant of the material allows for strong dissociation of ions, which in turn leads to high solubility of lithium salts.

The glass transition temperature (T_{g}) of a polymer is indicative of the how easy or difficult it is for polymer chains within the structure to freely move around and is thus indicative of how easily ions can be transported through the structure. The glass transition temperature of amorphous polymers represents the temperature at which the polymer transitions from being stiff and brittle to being soft and rubbery. So, by lowering the glass transition temperature of the polymer, segmental motion is increased and hence the conductivity is increased.

The use of branched polymers instead of linear polymers in the disclosed polymeric materials is also advantageous as compared to previous approaches since branching frustrates (i.e., interferes with) the chain packing, preventing crystallization of the polymer. This manifests as the polymer being a relatively viscous liquid-like polymer instead of a solid due to a lowering of the glass transition temperature of the polymer. The presently disclosed high molecular weight functionalized polymers (alternatively referred to herein as “high dielectric polymers”) have both high dielectric permittivity and a low glass transition temperature, making them well-suited for use as polymer electrolyte in a lithium-ion battery.

The disclosed high dielectric polymers may be produced utilizing addition polymerization or anionic ring opening to produce a linear or branched polymer backbone containing numerous residual nucleophiles. Then, nucleophilic substitution may be carried out to functionalize the residual nucleophiles. Michael addition is a suitable method of nucleophilic substitution, but it is also possible to use alkyl halides for more standard S_{N}2 type nucleophilic substitution. For Michael addition, the linear or branched polymeric starting material, produced in the first step, and containing protic nucleophiles (—OH, —SH, —NH₂), acts as a polymeric Michael donor. A functional group that has an α, β-unsaturated C═C bond attached to a strong electron withdrawing group (EWG) acts as a Michael acceptor. The donor and acceptor are reacted in the presence of a catalyst causing the Michael acceptor to attach to the polymeric starting material. This functionalized polymer may then be purified.

In one aspect, methods of producing a high dielectric polymer are disclosed that include reacting a starting material containing at least three nucleophilic sites with a crosslinker to produce a polydonor, wherein the polydonor is a branched polymer containing a plurality of reactive nucleophilic sites, functionalizing the plurality of reactive nucleophilic sites of the polydonor to produce a high dielectric polymer, and purifying the high dielectric polymer. In the disclosed methods, the starting material may be selected from the group consisting of a polyalcohol (polyol), sorbitol, pentaerythritol, inositol, pentaerythritol, dipentaerythritol, an aminoalcohol, tris(hydroxymethyl)aminomethane, 2-Amino-2-methyl-1-propanol, 2-Amino-2-methyl-1,3-propanediol, cysteine, dithiothreitol, other thiols, and/or polyethyleneimine. In these and other methods, the starting material may be a Michael donor. In some embodiments, the plurality of nucleophilic sites may include —OH, —NH₂, and/or —SH groups. In these and other embodiments, the crosslinker may be a difunctional crosslinker. In some such embodiments, the crosslinker may be a diglycidyl ether, a dichloride, a dibromide, a diisocyanate, epichlorohydrin, a diacrylate, a divinyl, and/or a dialdehyde (e.g., divinyl sulfone, glycerol diglycidyl ether, PEG-diglycidyl ether, and/or epichlorohydrin). The disclosed methods may further include purifying the polydonor, if desired. In these and other embodiments, functionalizing the plurality of reactive nucleophilic sites may be accomplished by nucleophilic addition. In select embodiments, functionalizing the plurality of reactive nucleophilic sites may be accomplished by Michael addition. The methods may also include combining the high dielectric polymer with an electrochemically active material to form a polymer electrolyte. In some such embodiments, the methods may also include incorporating the polymer electrolyte into a lithium-ion battery as an anolyte or a catholyte.

In another aspect, an electrochemical cell is disclosed that includes an anode having a first electrochemically active material, a cathode having a second electrochemically active material, a first electrolyte positioned within either the anode or the cathode, and a second electrolyte interposed between the anode and the cathode. At least one of the first electrolyte and the second electrolyte includes a high dielectric polymer having dielectric permittivity greater than 10 and a glass transition temperature less than −30° C. In some such embodiments, the dielectric permittivity of the high dielectric polymer is greater than 20 and the glass transition temperature is less than −70° C. In these and other embodiments, the second electrochemically active material includes lithium ions. In some such embodiments, the first electrolyte may include the high dielectric polymer.

In yet another aspect, a high dielectric polymer is disclosed that includes a branched and functionalized polymer backbone, and the high dielectric polymer has a dielectric permittivity greater than 10 and a glass transition temperature less than −30° C. The high dielectric polymer may be produced by functionalizing a plurality of nucleophilic sites of a polydonor, in some embodiments. An electrochemical cell may be formed that includes a polymer electrolyte containing the disclosed high dielectric polymer. In some such embodiments, the electrochemical cell may be a lithium-ion battery.

### BRIEF DESCRIPTION OF THE DRAWINGS

So that those having ordinary skill in the art to which the disclosed system pertains will more readily understand how to make and use the same, reference may be had to the following drawings.

FIG. 1 illustrates an example method of forming a polymer electrolyte configured in accordance with the subject disclosure;

FIG. 2 illustrates an example chemical reaction scheme of forming a high dielectric polymer configured in accordance with embodiments of the subject disclosure;

FIG. 3 illustrates an example reaction scheme of forming a polydonor as disclosed herein;

FIG. 4 illustrates example chemical reaction schemes for various difunctional crosslinkers that may be used in accordance with the disclosed methods;

FIG. 5 illustrates an example chemical reaction scheme for the production of a hyperbranched polyglycerol using n-butanol as the initiating molecule and glycidol as the monomer;

FIG. 6 illustrates a Michael addition between an alcohol and an amine;

FIG. 7 illustrates a Michael addition to primary alcohols with various acceptors;

FIG. 8 illustrates examples of nucleophilic additions between a nucleophile and an alkyl halide;

FIG. 9A illustrates the chemical structure of the high dielectric polymer obtained in Example 1;

FIG. 9B shows the differential scanning calorimetry (DSC) curve of the high dielectric polymer of FIG. 9A;

FIG. 9C illustrates the FTIR spectrum of the high dielectric polymer of FIG. 9A;

FIG. 10 illustrates the chemical reaction scheme to produce the polydonor of Example 5;

FIG. 11 illustrates the chemical reaction scheme to produce the polydonor of Example 7;

FIG. 12 shows a cross-section micrograph image of a composite cathode electrode containing the high dielectric polymer electrolyte of Example 8;

FIG. 13 shows exemplary cycling behavior of cathode half cells using the composite cathode electrode as described in Example 8 and shown in FIG. 12;

FIG. 14 shows a chart of measured dielectric permittivity for the high dielectric polymer of Example 1 and the high dielectric polymer produced from the polydonor described in Example 7;

FIG. 15 shows a chart of ionic conductivity measured as a function of salt concentration, for two different salts of polymer electrolytes produced from the polymer of Example 1; and

FIG. 16 shows a chart of measured conductivity of the high dielectric polymer described in Example 1 when made into a polymer electrolyte containing 40 wt % LiTFSI.

### DETAILED DESCRIPTION

Previous and current electrolytes for rechargeable lithium-ion batteries (as well as other types of electrochemical cells) have significant shortcomings. Specific shortcomings of conventional liquid electrolytes, polymer electrolytes, and ceramic electrolytes are discussed below in detail, followed by a thorough description of the presently disclosed high dielectric polymers and related methods of manufacture and use.

Positive electrodes were commonly, but not exclusively, made using one or more positive active materials in single crystal or particulate form, mixed with an electrochemically inert but electronically conductive material, and a polymeric binder, and a solvent to make a slurry. The slurry was then coated onto both sides of an appropriate substrate such as, but not limited to aluminum foil. The coated substrate was then dried to remove the solvent. The assembly was then calendared, typically by passing the as-coated substrate between rollers to densify the electrode.

The process for producing the negative electrode was similar, but with negative active materials and a different substrate such as, but not limited to copper foil. By design, the as-assembled electrodes have a certain porosity and average pore size and pore size distribution that will enable contact with the nonaqueous electrolyte while providing the desired amount of energy density. The electrodes are separated by a separator, which is an electronically insulating but ionically conducting membrane, with pre-designed porosity and pore properties, the pore space is filled with liquid organic solvent containing dissolved lithium salt. The mixture of the organic solvent and lithium salt is known as an electrolyte and is necessary for the transport of lithium ions to and from the positive and negative electrodes. The separator may have more than one layer. This typically includes a polyolefin layer that melts at a temperature well below the temperature of thermal runaway—a type of catastrophic failure of the cell—and can shutdown electrochemical reaction by closing its pores during the melting. Unfortunately, the dimensional stability of these membranes is poor and can shrink at elevated temperatures thus allowing the positive and negative electrodes to come into physical contact. This creates a short circuit that leads to catastrophic thermal runaway event. To mitigate this failure, one or two heat-resistant layers are attached to the shutdown layer. The heat resistant layer consists of a bonder and heat resistant fine particles comprised of, but not limited to Al₂O₃, SiO₂, or TiO₂ with sizes usually in the range, but not limited to 0.2 to 2.0 microns, present in a concentration that can minimize the shrinkage of the assembled separator layers to an amount that does not allow the electrodes of the cell to come into contact with each other.

Conventional electrolytes used in Li-ion batteries contain mixtures of highly flammable liquids such as, but not limited to cyclic carbonates such as ethylene carbonate, and linear carbonates such as diethyl carbonate which can lead to thermal runaway events should the battery become shorted, overcharged, over heated, or experience some other failure. Flammability of the electrolyte and the generally safety of Li-ion batteries is exacerbated by the presence of the positive electrode, normally, but not limited to a lithium-containing transition metal oxide of some sort. These transition metal oxides can act as solid oxygen sources, releasing oxygen when they are heated, allowing Li-ion batteries to continue burning even when air is no longer supplied.

In order to overcome these safety issues, researchers have looked at replacing the conventional flammable liquid electrolytes with thermally robust polymer electrolytes and ceramic electrolytes. Ceramic electrolytes offer high intrinsic conductivity, on the order of 10⁻³-10⁻² S/cm but require high processing temperatures, can be exceptionally air/moisture sensitive, and often suffer from being brittle and rigid leading to interfacial contact issues with the positive and negative electrodes. Polymer electrolytes have been studied since the 70's with polyethyleneoxide (PEO) being by far the most studied. However, PEO suffers from relatively low conductivity at ambient temperatures, with most PEO-salt formulations reaching conductivities of only 10⁻⁶-10⁻⁴ S/cm at room temperature and showing only significant conductivity at temperatures>60° C. This is in part due to the nature of Li⁺ transport within PEO. PEO, having a relatively low dielectric permittivity of ˜6-7, relies on forming a strong chelation complex with in which Li⁺ four ethers are wrapped around the central Li⁺. This chelation structure leads to relatively low transference number for Li⁺ within the system, so most of the measured conductivity is due to anion transport, which does not meaningfully contribute to the performance of the battery. This chelation structure also leads to interchain transport of Li⁺ dominating over intrachain transport. Therefore, Li⁺ transport in PEO is primarily via segmental (or segmented) motion within a chain, and hence requires elevated temperatures to achieve useful conductivities. One method for increasing the amount of segmental motion at a given temperature is to lower the glass transition temperature of the polymer. This can be achieved, to some extent, through decreasing the molecular weight of the polymer, or by creating a branched polymer structure. Polymers that have a high degree of branching will generally pack less efficiently (i.e., have more excess free volume, and lower density) and consequently will have lower glass transition temperatures than their linear counterparts. Using branched structures in place of linear can effectively increase the conductivity of polymer gel electrolytes (where the polymer gel consists of a polymeric matrix swelled with a small molecule liquid containing a dissolved lithium salt), with higher degrees of branching showing better conductivity.

One key aspect of solvents for battery electrolytes is that they should have a relatively high dielectric permittivity in order to promote a high degree of ion dissociation, allowing for high conductivity. Standard organic solvents such as ethylene carbonate (ε≈90), propylene carbonate (ε≈64), and acetonitrile (ε≈36), have dielectric constants 6-15 times higher than PEO. It has been proposed that for a polymer electrolyte to reach sufficient conductivity for practical applications the dielectric permittivity should be >10 and preferably >20 with the dielectric permittivity remaining high at frequencies on the order of the ion hopping rate, or >10⁶ Hz. In order to achieve a high dielectric permittivity with a polymer, functional groups that contain high dipole moments can be incorporated and should have a relatively high mobility in order to maintain the high dielectric permittivity at higher frequencies. It has been demonstrated through molecular dynamics simulations that there exists an optimal balance of the density of high dipolar functional groups that allows for high amounts of ion-pair dissociation without excess dipole-dipole interactions of the polymer that would lead to low free volume and a lowering of the dielectric permittivity at higher frequencies.

In addition to improvements in safety, the development of bulk polymer electrolytes allows for new electrode processing and manufacturing methods. As the polymers could be utilized in the melt state, electrodes could be manufactured in solvent free processes such as extrusion. This would allow for a simplified electrode production method, lowering costs of manufacturing. In some aspects, the present disclosure provides a polymer that possesses a dielectric permittivity>10, many embodiments >20, and maintains this high dielectric permittivity at relevant frequencies and temperatures. In other aspects, the disclosure provides methods for manufacturing these polymers into electrodes, and secondary Li-ion batteries.

### Definitions

The following terms as used herein are to be understood as having the meanings described below as well as their customary technical meanings unless the customary meaning conflicts with the definition provided herein.
Polymer—A molecule consisting of several repeat units covalently bonded to each other. Herein used to reference the reaction product of a Michael donor with a crosslinker (defined below in polydonor) and the reaction product of a Michael acceptor with the polydonor (defined below).
Michael Addition—A conjugate addition reaction between a Michael donor and Michael acceptor.
Michael Donor—Any molecule containing a protonated nucleophile or carbanion. Example nucleophiles include alcohols (—OH), amines (—NH₂, —NH—), and thiols (—SH). Other nucleophiles include —PHₓO₃₋ₓ where 0≤x<4, and active methylenes such as malonates and nitroalkanes.
Michael acceptor—Any molecule containing an α, β-unsaturated carbon with a strong electron withdrawing group attached. Both the α and β carbon to the electron withdrawing group may be unsubstituted, but this is not strictly necessary and only allows for a faster, more efficient reaction due to the more favorable sterics.
Crosslinker—Any difunctional molecule that can react with the Michael donor to produce oligomers and polymers. Example crosslinkers include but are not limited to: diglycidyl ethers, di-halogenated organic compounds, diisocyanates, divinyls, and diacrylates.
Catalyst—Any molecule or energy source used to enhance the reaction rate of the crosslinker with the Michael donor, or the nucleophiles of the Michael donor with the Michael acceptor. Example bases that may be used include lithium hydroxide (LiOH), sodium hydroxide (NaOH), potassium hydroxide (KOH), cesium carbonate (Cs₂CO₃), potassium carbonate (K₂CO₃), lithium methoxide (LiOMe), lithium tert-butoxide (LiOt-Bu), potassium tert-butoxide (KOt-Bu. However, strong Brønsted acids such as bistriflimidic acid (HTFSI), tetrafluoroboric acid (HBF₄), hexafluorophosphoric acid (HPF₆), triflic acid (HOTf), as well as strong Lewis acids have also been shown to be efficient catalysts for Michael addition and may also be used. Ultraviolet radiation, infrared radiation, and/or heat may also be used as a catalyst for any suitable chemical reactions described herein.
Polydonor—The polymeric reaction product of one or more Michael donors with one or more crosslinkers as defined above.
High dielectric polymer—The purified, polymeric reaction product of a polydonor with one or more Michael acceptors.
Salt—A compound containing two or more moieties that are ionically bonded, and capable of being dissociated by a suitable solvent.
Polymer Electrolyte—A mixture of one or more high dielectric polymer(s), with one or more lithium salt(s), with or without one or more additives present.
Additive—Any compound added to the polymer electrolyte in quantities <10 wt % to obtain more desirable properties (e.g., to improve processing, mechanical properties, or for electrochemical performance) of the produced polymer electrolytes and batteries.
Plasticizer—A subclass of additives that acts to lower the viscosity and/or glass transition temperature of the high dielectric polymer and/or polymer electrolyte.
Co-Solvent—A subclass of additives used to promote the dissociation of a lithium salt(s) when, for a given loading of salt, the high dielectric polymer is not capable of fully dissociating the salt.

### Methods of Forming a High Dielectric Polymer

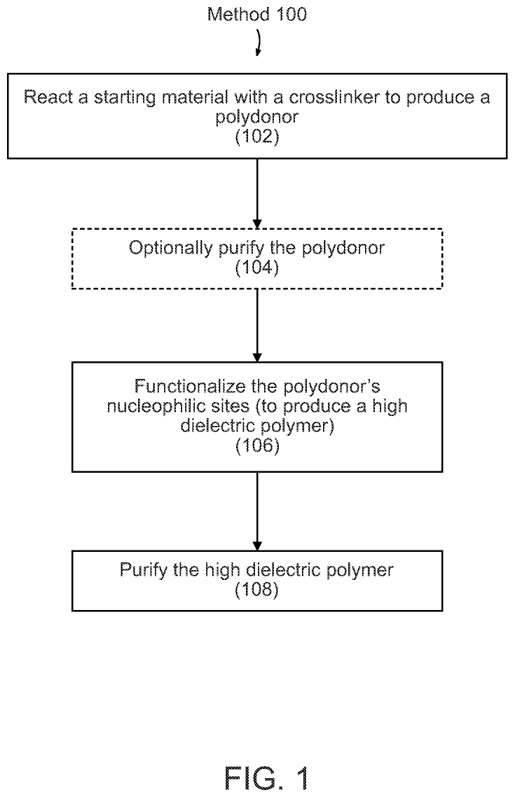

As previously mentioned, the subject disclosure describes a unique high dielectric polymer as well as methods of using the high dielectric polymer in an electrochemical cell (e.g., a lithium-ion battery). FIG. 1 illustrates an example method of producing a high dielectric polymer in accordance with various embodiments of the subject disclosure.

As shown in FIG. 1, method 100 includes reacting a starting material with a crosslinker to produce a polydonor (Block 102). The starting material may be any compound having 3 or more reactive nucleophilic sites. In some embodiments, the starting material may be a Michael donor molecule. In select embodiments, the starting material may be a polyalcohol (polyol), such as sorbitol, pentaerythritol, inositol, pentaerythritol, dipentaerythritol, or other polyols, tris(hydroxymethyl)aminomethane, 2-Amino-2-methyl-1-propanol, 2-Amino-2-methyl-1,3-propanediol, or other aminoalcohols, cysteine, dithiothreitol, other thiols, and/or polyethyleneimine. The crosslinker may be any suitable type of difunctional molecule (i.e., reactive with the nucleophilic sites of the starting material). Exemplary crosslinkers include but are not limited to diglycidyl ethers, dichlorides, dibromides, diisocyanates, epichlorohydrin, diacrylates, divinyls, and/or dialdehydes.

To complete the reaction of the starting material and crosslinker (Block 102), the starting material is dissolved in an appropriate solvent, with or without a catalyst, such as potassium hydroxide (KOH), sodium hydroxide (NaOH), lithium hydroxide (LiOH), potassium carbonate (K₂CO₃), cesium carbonate (Cs₂CO₃), triethylamine (TEA), 1,8-Diazabicyclo[5.4.0]undec-7-ene (DBU), magnesium oxide (MgO), barium oxide (BaO), or aluminum oxide (Al₂O₃).

The crosslinker may added dropwise to the starting material mixture under heavy stirring, at a temperature appropriate for the reaction. Adding the crosslinker in a dropwise manner to the starting material solution ensures that there is always an excess of starting material (e.g., Michael donor) present so that, statistically, each reactive group of the crosslinker will react with two different starting material molecules. As the crosslinker is added dropwise to the vigorously mixing solution of starting material, oligomers are formed and will eventually begin to link up, forming polymers. Because the oligomers and polymers contain numerous residual reactive sites, the addition polymerization will lead to a randomly branched polymeric structure. Depending on the starting material, crosslinker, and temperature, a catalyst may or may not be necessary or desired for the reaction to proceed. Furthermore, for certain crosslinkers such as chlorides and bromides, a compound such as NaOH or triethylamine should be present in at least equimolar ratio to the chloride/bromide concentration to neutralize or scavenge HCl and HBr as they are produced from the reaction of the chloride/bromide with the Michael donor. The reaction is allowed to proceed for long enough to ensure all reactive groups of the crosslinker have been reacted. The polymer produced in this step is referred to as a polydonor (as it is the polymeric version of the Michael donor starting material used).

An alternative method to addition polymerization for production of the branched polydonors is through anionic ring opening polymerization of glycidol, modified glycidyl ethers, oxiranes, oxetanes, and mixtures thereof. In these embodiments, preparation of a hyperbranched polydonor is carried out using a seeding monomer that contains one or more alcohol, amine (primary or secondary), or thiol, followed by addition of a strong base such as lithium methoxide, followed by addition of glycidol. The ring structure of glycidol will react with the deprotonated nucleophile, opening and forming a carbon-nucleophile bond, producing a secondary and primary alcohol at the same time. The primary and secondary alcohol that are produced from this reaction then provide two new nucleophilic sites for more glycidol to react with. This process leads to a hyperbranched polyether structure with numerous residual nucleophiles. The molecular weight of the resulting hyperbranched polymer can be controlled by varying the ratio of seeding monomer to glycidols, oxiranes, and oxetanes. The lower the ratio of seeding monomer to glycidols, oxiranes, and oxetanes, the higher the molecular weight of produced polymers.

The classic example of branched polydonor produced in this way, is hyperbranched polyglycerol (HPG). HPG is produced via anionic ring opening polymerization of glycidol in the presence of various seeding monomers such as butanol, ethane diol, tris(hydroxymethyl)propane, etc. This leads to HPG that have various degrees of branching and a high density of alcohols in the structure. By copolymerizing glycidol with oxiranes or oxetanes that don't contain nucleophiles such as hydroxides, it is possible to adjust the final concentration of nucleophiles in the structure, and by corollary control the final concentration of functionalized high dielectric groups in the final high dielectric polymer.

After the polydonor backbone has been produced, it can be purified (Block 104). Although discussed herein and shown in FIG. 1, purification of the polydonor may not always be necessary. Purification can be advantageous when the reaction solvent or catalyst used for production of the polydonor are unsuitable for the functionalization step (Block 106). If both the solvent and catalyst for the polydonor synthesis (Block 102) are suitable for the functionalization step (Block 106), purification of the polydonor (Block 104) can be avoided to minimize the number of steps and maximize yield.

If undertaken, purification of the polydonor (Block 104) can usually be achieved by (1) neutralizing the base catalyst, (2) removing the solvent, and (3) removing any non-polymeric compounds (e.g., salt from neutralization, oligomers from the reactions, or residual monomers). For ease of processing, the polydonor can be redissolved in a solvent, though this is not strictly necessary.

Method 100 continues with functionalizing the polydonor's nucleophilic sites (Block 106). In some embodiments, the polydonor's nucleophilic sites may be functionalized via Michael addition with one or more Michael acceptors. Michael acceptors include but are not limited to acrylonitrile, 2-sulfolene, methyl vinyl sulfone, ethyl vinyl sulfone, fumaronitrile, ethene sulfonyl fluoride, N-methylmaleimide, vinyl phosphonic acid, dimethyl vinyl phosphonate, methyleneflutaronitrile, lithium vinyl sulfonate, and methyl vinyl ether. Michael acceptors, more generally, are compounds containing an α, β-unsaturated carbon bond with an electron withdrawing group attached.

Similar to the reaction of the starting material and crosslinker (Block 102), a base catalyst may or may not be necessary for the functionalization reaction of the polydonor's nucleophilic sites (Block 106) to proceed. A catalyst can be helpful when the active nucleophiles are alcohols or thiols. If a catalyst is to be used for the reaction, first a base catalyst is added to the polydonor and mixed thoroughly. The polydonor-catalyst mixture is then added dropwise to a solution of Michael acceptor(s), with the Michael acceptor being present at 1.2-10× excess molar ratio relative to the moles of nucleophilic sites present in the polydonor. Adding the polydonor dropwise under vigorous stirring to an excess of the Michael acceptor can be advantageous as it ensures that the nucleophilic sites of the polydonor react quickly. However, the reaction can also be carried out by adding the Michael acceptor(s) dropwise to a vigorously mixing solution of the polydonor and catalyst.

The functionalization reaction of the polydonor (Block 106) can be carried out at ambient temperature. However, in other embodiments, the reaction proceed when chilled to below ambient, or heated above ambient, depending on the reactivity of the given polydonor, catalyst, and Michael acceptor. For instance, when using acrylonitrile as a Michael acceptor and NaOH as the base catalyst, it is preferred to keep the reaction temperature<30° C. to avoid anionic attack of the acrylonitrile by the OH⁻ anion. In the case of high polarity, with aprotic solvents such as dimethylsufloxide (DMSO), and with acrylonitrile as the Michael acceptor, it is preferred to keep the temperature at sub-ambient with active cooling to avoid runaway reactions of the excess acrylonitrile. In absence of controlling the temperature carefully, or using too much catalyst, polymerization solutions can become discolored due to excess side reactions between the catalyst and the Michael acceptor. Once the polydonor and Michael acceptor have been fully combined, the reaction is allowed to proceed to completion. The final product, consisting of the polydonor functionalized with the Michael acceptor(s) is referred to as a high dielectric polymer.

If a catalyst is used to produce the high dielectric polymer, an equimolar amount of acid may be added to neutralize the system. After neutralization, any solvent and residual Michael acceptor may be removed. The high dielectric polymer may then be purified (Block 108). Various purification techniques may be used to purify the high dielectric polymer, including redissolving the high dielectric polymer in a solvent and removing residual salts from neutralization and any side products of the reaction. After this initial purification is complete, a final purification may be carried out by removing the solvent, redissolving the high dielectric polymer in an anhydrous solvent, and adding a desiccating agent such as, but not limited to, MgSO₄, Na₂SO₄, CaH₂, or molecular sieves in order to lower the moisture content to <100 ppm, preferably <20 ppm, and more preferably <2 ppm. Once desiccated, the solvent can be removed from the high dielectric polymer or left in for ease of further processing.

It is important to note that the polydonor may be functionalized (Block 106) by methods other than Michael addition. For example, in some embodiments, the polydonor may be functionalized via nucleophilic substitution using an alkyl halide. The process is similar to Michael addition, in that a base catalyst is used, but requires the use of a base in at least equimolar amounts to the alkyl halide that is being added. Suitable alkyl halides for this process include, but are not limited to: 4-Bromobutyronitrile, 3-bromopropionitrile, 4-chloropropionitrile, 1-bromo-2-(methylsulfonyl)ethane, and 1-Bromo-2-(methylsulfonyl)propane. To carry out this functionalization, the polydonor is first dissolved in an aprotic solvent, such as acetonitrile (ACN), tetrahydrofuran (THF), dioxane, dioxolane, dimethyl sulfoxide (DMSO), dimethylformamide (DMF), or another suitable solvent. Next a base is added in equimolar amounts to the alkyl halide that will be used. Suitable bases include but are not limited to alkali metal carbonates such as lithium carbonate, sodium carbonate, potassium carbonate, alkali metal hydroxides, such as lithium hydroxide, sodium hydroxide, potassium hydroxide, alkali alkoxides such as lithium methoxide, sodium ethoxide, potassium terbutoxide, or tertiary amines such as triethylamine (TEA). Other suitable bases include lithium diisopropylamide (LDA), lithium hydride, and sodium hydride. To the solution containing the polydonor and base, the alkyl halide is added and allowed to react. The products of this reaction are a high dielectric polymer and a salt of the halide and base that were utilized. For example, if TEA is used as a base and 3-bromopropionitrile is used as an alkyl halide, the byproduct will be triethylammonium bromide, i.e., the bromine salt of triethylamine. Once the polydonor has been functionalized via nucleophilic addition of an alkyl halide to produce a high dielectric polymer, it can be purified (Block 108), taking extra care to ensure that the excess halide salt is fully removed.

The high dielectric polymers produced by method 100 may have distinctive characteristics as compared to other polymers. For example, in some embodiments, the disclosed high dielectric polymers may have a dielectric permittivity greater than 10, and in some embodiments, greater than 20, 25, 30, 35, 40, 45, or 50. In these and other embodiments, the presently disclosed high dielectric polymers may have a glass transition temperature (T_{g}) less than −30° C., such as less than −70° C., −80° C. −90° C., or −100° C. A high dielectric polymer that also has a relatively low glass transition temperature can present meaningful advantages as a polymer electrolyte as compared to conventional electrolytes.

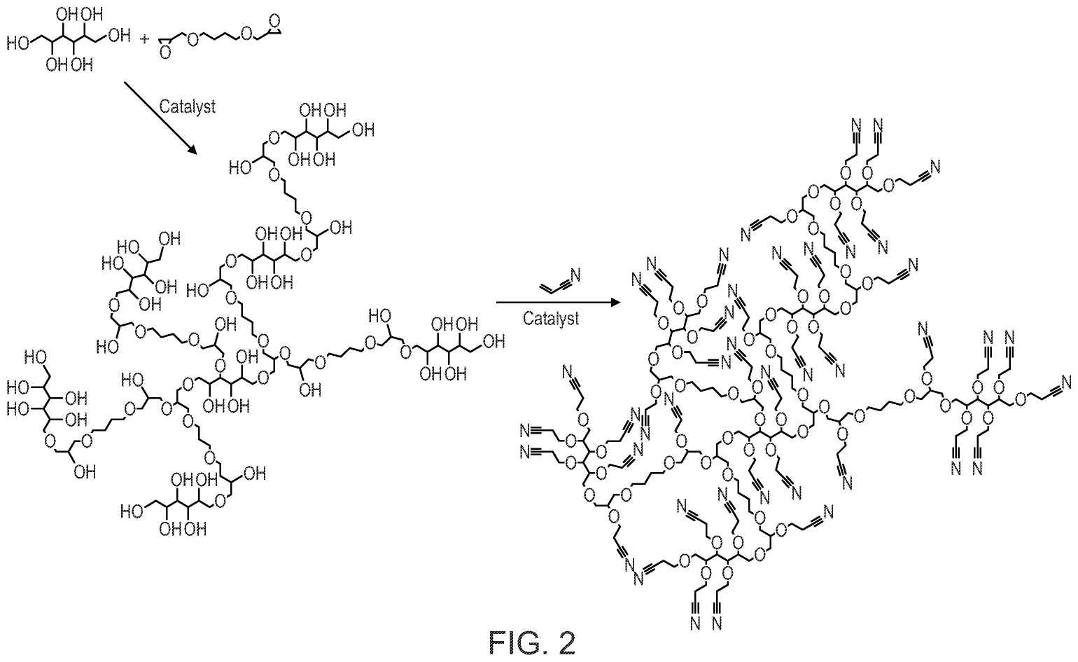

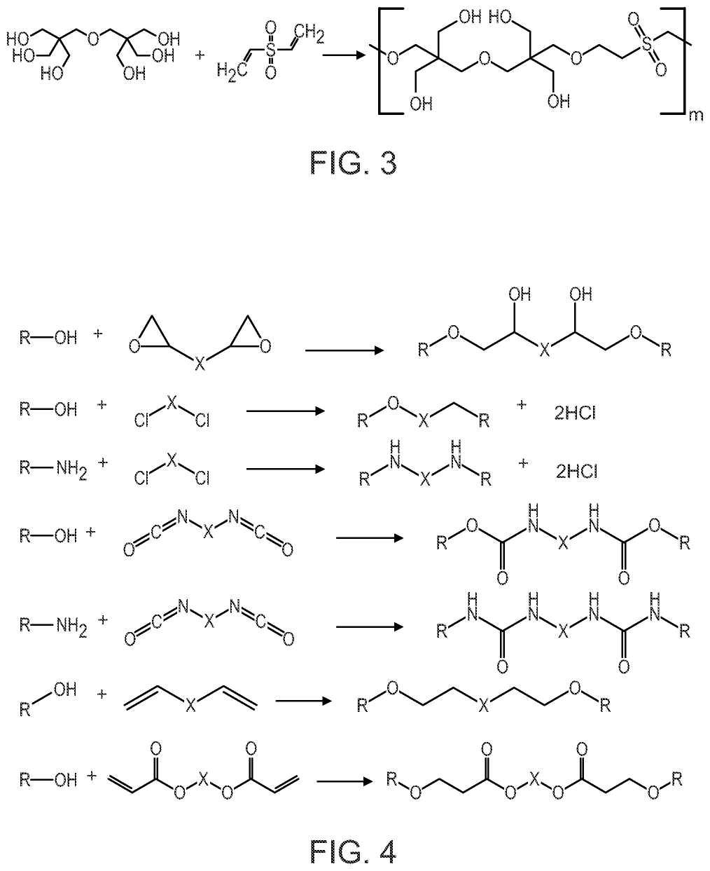

FIG. 2 illustrates a chemical reaction scheme in which a high dielectric polymer is produced using the method 100 of FIG. 1. In particular, FIG. 2 shows the reaction of sorbitol (starting material) with butanediol diglycidyl ether (crosslinker) to form the branched polydonor, followed by Michael addition functionalization with acrylonitrile to form the high dielectric polymer. FIG. 3 illustrates an example reaction scheme of forming a polydonor via reaction of dipentaerythritol (starting material) with divinyl sulfone (crosslinker). Although the polydonor product is shown as linear, in reality, the structure would be randomly branched since all of the primary alcohols will be equally likely to react with the divinyl sulfone.

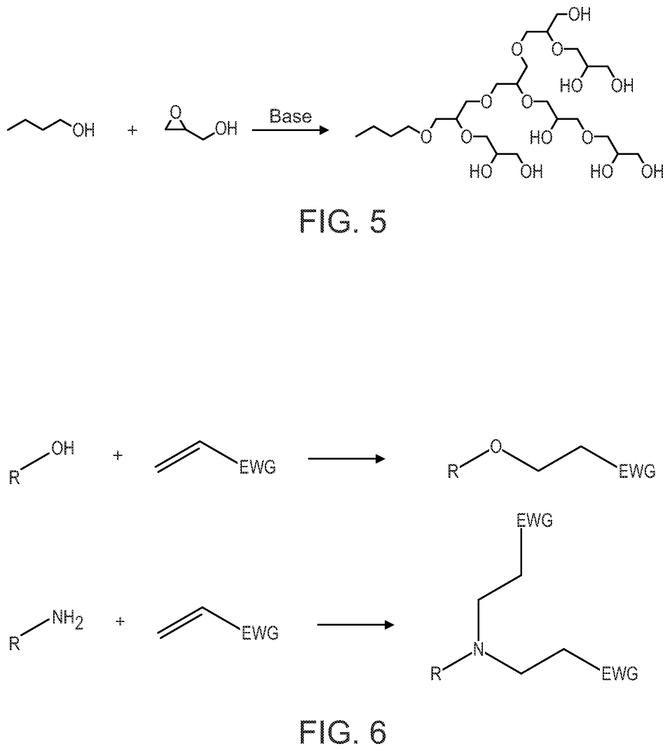

FIG. 4 illustrates chemical reaction schemes for various difunctional crosslinkers. In particular, diglycidyl ethers, dichlorides (alcohol donor), dichlorides (amine donor), diisocyanates (alcohol donor), diisocyanates (amine donor), divinyls, and diacrylates are shown in FIG. 4. As used in FIG. 4, “X” represents any core molecular structure and “R” represents any donor molecule. FIG. 5 illustrates an example reaction for the production of hyperbranched polyglycerol using n-butanol as the initiating molecule and glycidol as the monomer. The molecular weight of the final polymer of FIG. 5 will be determined by the ratio of the initiating molecule to glycidol. FIG. 6 illustrates a Michael addition between an alcohol, —OH (note that this reaction is equivalent to if a thiol, —SH, was used), and an amine, —NH₂.

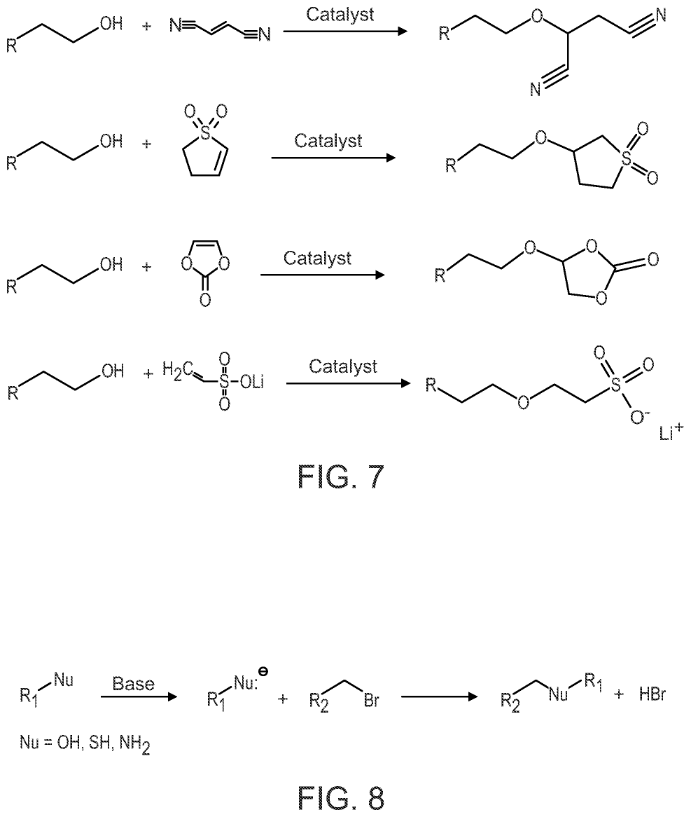

FIG. 7 illustrates Michael addition to primary alcohols with various acceptors. In particular, FIG. 7 illustrates fumaronitrile, 2-sulfolene, vinylene carbonate, and lithium vinyl sulfonate reactions.

FIG. 8 illustrates examples of nucleophilic additions between a nucleophile (—OH, —SH, NH₂) and an alkyl halide (an alkyl bromide).

### Methods of Producing a Polymer Electrolyte

To produce a polymer electrolyte from the presently disclosed high dielectric polymer, the high dielectric polymer is mixed with one or more lithium salts, and optionally one or more additives. Exemplary lithium salts include but are not limited to: Lithium hexafluorophosphate (LiPF₆), lithium tetrafluoroborate (LiBF₄), lithium bis(trifluoromethanesulfonyl)imide (LiTFSI), lithium bis(fluorosulfonyl)imide (LiFSI), lithium bis(oxalato)borate (LiBOB), lithium difluoro(oxalato)borate (LiDFOB), lithium difluorophosphate (LiDFP), Lithium triflate (LiOTf), and lithium nitrate (LiNO₃). Standard ranges for the lithium salt concentration with respect to the high dielectric polymer are 5-40% by weight, depending on the solubility of the salt, and the performance of the final mixture. Polymer-in-salt electrolytes can also be produced by increasing the salt concentration to >50 wt %. LiFSI, for instance, is soluble in some high dielectric polymers to at least 75 wt %. The nature of ion conduction in these polymer-in-salt mixtures is expected to be different than in the standard polymer electrolytes.

Aside from lithium salts, additives may also be added to the high dielectric polymer to obtain higher conductivities, more stable cycling of the battery, enhance the mechanical properties of the produced electrodes, enhance safety, decrease flammability, and/or provide more desirable rheological properties that facilitate downstream processing. For example, addition of triethylphosphate can lead to decreased flammability, while also boosting electrolyte conductivity. Addition of dimethyl carbonate (a low boiling point, low dielectric, high volatility solvent) can be used to lower the viscosity to allow for better film formation during slurry coating of electrodes, and can later be easily removed with heat. Addition of fumed silica can be used to increase the viscosity and stiffness of the polymer electrolyte, facilitating calendaring of the electrode mixture.

The disclosed polymer electrolyte can be incorporated into an electrochemical cell, if desired. The polymer electrolyte may be used in an electrode, a standalone dielectric, or as a non-electrochemically active electrolyte interposed between electrodes. In a lithium-ion battery, the polymer electrolyte may be used in an anode, cathode, and/or as a standalone dielectric, non-electrochemically active electrolyte interposed between anode and cathode electrodes. The standalone dielectric, non-electrochemically active electrolyte can be thermoformed onto the anode or cathode by heating and affixing the polymer electrode thereto, such as with a lamination process. In other embodiments, the polymer electrolyte may be joined to anode or cathode by a co-extrusion process. In embodiments wherein the polymer electrolyte is used as anolyte or catholyte, the polymer electrolyte may be laminated to a current collector using conventional techniques known to those of ordinary skill in the relevant art.

Lithium salts may be used for the polymer to work as an electrolyte in Li-ion batteries and can be generalized as “LiA,” where A represents any anionic species. These salts can be added in any suitable amount (e.g., 25%-50% by weight) to obtain optimal properties for battery performance.

In order to further improve the ionic conductivity of the polymer, passivate active material surfaces, enhance safety, or obtain specific rheologic properties necessary for processing, additives can be used. These additives include, but are not limited to, oligomeric (short chain polymers, generally less than 10 mer units) version of the polymer, small molecule additives (diethyl carbonate, sulfolane, pivalonitrile, ethylene carbonate, phosphazenes, triethyl phosphate, etc.), and ceramic powders (fumed silica, nano lithium lanthanum zirconate (LLZO), nano alumina). As described in detail herein, the term polymer electrolyte refers to the mixture of the aforementioned polymer, lithium salt(s), and any additives(s) present.

The as-produced polymer electrolyte may then be incorporated with an active material, a conductive additive, and, if necessary or desired, a binder material. This mixture may then be processed to produce a thin, film like structure that will become the electrode (either positive or negative electrode). Once the film is produced it may be applied to a metallic substrate that will act as a current collector.

In some aspects, an electrochemical cell comprising a polymer electrolyte containing a high dielectric polymer as described herein is disclosed. In some embodiments, the electrochemical cell is a lithium-ion battery. The electrochemical cell may include an anode comprising a first electrochemically active material, a cathode comprising a second electrochemically active material, a first electrolyte positioned within either the anode or the cathode, and a second electrolyte interposed between the anode and the cathode. In some such embodiments, at least one of the first electrolyte and the second electrolyte may comprise a high dielectric polymer as described herein (e.g., a high dielectric polymer having dielectric permittivity greater than 10 and a glass transition temperature less than −30° C.). In these and other embodiments, the dielectric permittivity of the high dielectric polymer may be greater than 20 and the glass transition temperature may be less than −70° C. The second electrochemically active material may comprise lithium ions, in some embodiments. In these and other embodiments, the first electrolyte may comprise the high dielectric polymer.

### WORKING EXAMPLES

### Example 1: Preparation of a High Dielectric Polymer

To a 500 mL round bottom flask, a magnetic stir bead was added. Next, 20.0 g (110 mmol) of sorbitol, 3.25 g (10 mmol) of cesium carbonate, and 100.0 g of Dimethylformamide (DMF) was added to the flask. The flask was then capped with a silicone septum stopper and placed in an oil bath on a heated stir plate. A temperature probe was connected to the heated stir plate and submerged within the oil. The temperature was set to 100° C. and stirring was set to 600 rpm. Two stainless steel needles (20 gauge) were used to puncture the septum stopper. One of the needles was connected to a Schlenk line and used to purge the head space of the round bottom flask with nitrogen gas at a rate of 1 Standard Cubic Feet per Hour (SCFH). The second needle acted as a relief, preventing pressure build up. The sorbitol, cesium carbonate, DMF mixture were allowed to mix for 1 hour.

Meanwhile, a 50 mL round bottom flask was filled with 48.3 g (109 mmol based on the epoxide number supplied in the Certificate of Analysis (COA)) of polyethylene glycol diglycidyl ether (Mₙ=400) and capped with a silicone septum stopper. The silicone septum stopper was punctured with two needles. One needle was used to allow for pressure equalization of the flask and the other needle was used to insert capillary tubing to the bottom of the flask, and then connected to a 1/16″ ID, ⅛″ OD peristaltic pump tubing and connected to a Ismatec Reglo Compact Cassette Pump. The other end of the tubing was connected via a needle into the flask containing the sorbitol, cesium carbonate, DMF mixture. The peristaltic pump was then set to 2 rpm and allowed to run overnight or 14-24 hrs. Afterwards, all needles and tubing were disconnected, and the flask containing the polydonor in DMF was removed from heat. The silicone stopper was removed from the flask, and a PTFE sleeve was inserted. The flask was then connected to a rotary evaporator equipped with a bump trap and all of the DMF was removed from the mixture.

The product was a mixture of polydonor and cesium carbonate. This mixture was then dissolved in 10.0 g of methanol and 60.0 g of tetrahydrofuran and connected to the peristaltic pump in the same manner as described for the polyethylene glycol diglycidyl ether. To a second 500 mL flask, a magnetic stir bead was added along with 200 g of acrylonitrile, and then capped with a silicone septum stopper. The flask containing acrylonitrile was then placed in an oil bath at 35° C. The polydonor, cesium carbonate dissolved in MeOH/THF was then added via the peristaltic pump at 15 rpm. Once fully added, the reaction was allowed to continue overnight.

Once complete, any precipitated cesium carbonate was filtered off, and the mixture was brought to neutral using 1M HCl. The residual solvents, THF, Acrylonitrile were removed via rotary evaporation in the same manner as used previously. CsCl salt was seen to precipitate out after all the solvents were removed. The high dielectric polymer was then dissolved in excess acetone and centrifuged to remove CsCl. Acetone was then removed by rotary evaporation.

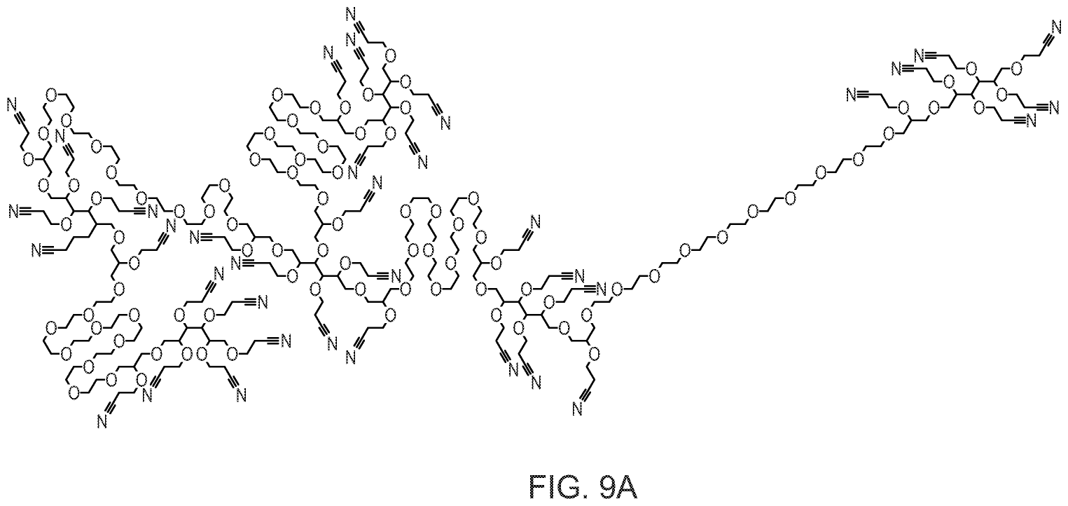

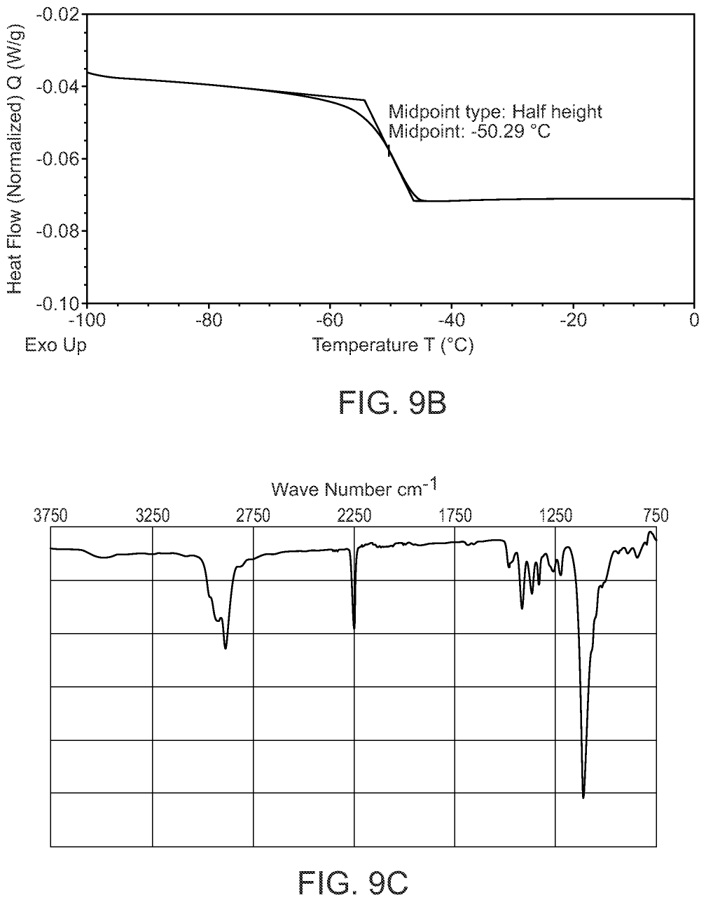

The resulting high dielectric polymer was transferred to a dry room and dissolved in acetonitrile to ˜50 wt %, and several grams of MgSO₄ was added and mixed in to act as a desiccant. The mixture was centrifuged to separate the MgSO₄ from the solution. The polymer acetonitrile solution was decanted from the MgSO₄. A sample was dried to remove the acetonitrile, FTIR was used to confirm the structure, and the dielectric constant was measured using a Keysight E4980AL precision LCR meter in the range of 10²-10⁶ Hz. At 1 MHz, the dielectric constant was 33.22. Differential scanning calorimetry was used to determine the glass transition temperature, which was found to be approximately −50° C. FIG. 9A illustrates the chemical structure of the resulting high dielectric polymer obtained in this example and FIG. 9B shows the differential scanning calorimetry (DSC) curve of the high dielectric polymer. FIG. 9C illustrates the FTIR spectrum of the high dielectric polymer and indicates virtually no residual alcohols in the structure (lack of peak between 3000-3500 cm⁻¹), a strong nitrile peak (2250 cm⁻¹), and a strong ether peak (1100 cm⁻¹).

### Example 2: Preparation of Polymer Electrolyte

The high dielectric polymer produced in Example 1 was used to prepare a polymer electrolyte. Prior to use, all solvent was removed from the high dielectric polymer using a rotary evaporation unit. Electrolyte was prepared using a FlackTek Speedmixer with a Max 40 cup. To the plastic cup, 10.0 g of high dielectric polymer from Example 1 was added, followed by 2.50 g of LiTFSI salt. The cup was capped and mixed at 800 rpm for 15 seconds, 1400 rpm for 15 seconds, 2000 rpm for 1 minute, and 2600 rpm for 1 minute. After mixing, the solution was checked for transparency. If signs of undissolved salt were present, the cup was placed in a 60° C. oven for 5 minutes, returned to the Speedmixer, and mixed again using the aforementioned mixing profile. This process was repeated until all the lithium salt had dissolved. The product was 12.5 g of a highly viscous, transparent polymer electrolyte containing 20% by weight LiTFSI salt. The conductivity of the as produced electrolyte was measured to be approximately 0.4 mS/cm at 25° C.

### Example 3: Preparation of a Polymer Electrolyte

Prior to use, all solvent was removed from the high dielectric polymer. Electrolytes were prepared using a FlackTek Speedmixer with a Max 40 cup. To the plastic cup, 5.0 g of high dielectric polymer from Example 1 was added, followed by 9.286 g of LiFSI salt. The cup was capped and mixed at 800 rpm for 15 seconds, 1400 rpm for 15 seconds, 2000 rpm for 1 minute, and 2600 rpm for 1 minute. After mixing, the solution was checked for transparency. If signs of undissolved salt were present, the cup was placed in a 50° C. vacuum oven for 5 minutes while pumping vacuum to degas, then returned to the Speedmixer, and mixed again using the aforementioned mixing profile. This process was repeated until all of the lithium salt had dissolved. The product was 14.286 g of a glassy, ultra-high viscosity, transparent polymer electrolyte containing 65% by weight LiFSI salt. In order to obtain appropriate rheology for further processing into positive electrodes, 1.587 g of diethylcarbonate (DEC) was added to the mixing cup, and the above mixing step was repeated. The product was 15.873 g of highly viscous polymer in salt electrolyte.

### Example 4: Preparation of a High Dielectric Polymer

To a 250 mL round bottom flask, a magnetic stir bead was added. Next, 20.0 g (110 mmol) of sorbitol, 1.4 g (10 mmol) of potassium hydroxide (40 wt % aqueous solution), and 20.0 g of deionized water were added to the flask. The flask was then capped with a silicone septum stopper. The flask was place in an oil bath on a heated stir plate. A temperature probe was connected to the heated stir plate and submerged within the oil. The temperature was set to 60° C. and stirring was set to 600 rpm. Two stainless steel needles (20 gauge) were used to puncture the septum stopper. One of the needles was connected to a Schlenk line and used to purge the head space of the round bottom flask with nitrogen gas at a rate of 1 SCFH. The second needle acted as a relief, preventing pressure build up. The sorbitol, potassium hydroxide solution was allowed to mix for 1 hour. Meanwhile, a 50 mL round bottom flask was filled with 48.3 g (109 mmol based on the epoxide number supplied in the COA) of polyethylene glycol diglycidyl ether, Mₙ=400, and capped with a silicone septum stopper. The silicone septum stopper was punctured with two needles. One needle was used to allow for pressure equalization of the flask. The other needle was used to insert capillary tubing to the bottom of the flask, and was then connected to a 1/16″ ID, ⅛″ OD peristaltic pump tubing and connected to a Ismatec Reglo Compact Cassette Pump. The other end of the tubing was connected via a needle into the flask containing the sorbitol solution. The peristaltic pump was then set to 2 rpm and allowed to run overnight or 14-24 hrs. Afterwards, all needles and tubing were disconnected, and the flask containing the polydonor in deionized water was removed from heat and allowed to come to room temperature.

To a second 500 mL flask, a magnetic stir bead was added along with 200 g of acrylonitrile, and then capped with a silicone septum stopper. The flask containing acrylonitrile was then placed in an oil bath at 35° C. The polydonor, potassium hydroxide aqueous solution was then added via the peristaltic pump at 10 rpm. Once fully added, the reaction was allowed to continue overnight. Once complete, the mixture was brought to neutral using 1M HCl. The residual acrylonitrile and water were removed via rotary evaporation in the same manner as Example 1. KCl salt was seen to precipitate out after all the solvents were removed. The high dielectric polymer was then dissolved in excess acetone and centrifuged to remove KCl. Acetone was then removed by rotary evaporation. Lastly, the high dielectric polymer was transferred to a dry room and dissolved in acetonitrile to ˜50 wt %, and enough anhydrous MgSO₄ was added to ensure any residual water was scavenged (when using MgSO₄ as a desiccant, it was added until it failed to clump up and began to disperse evenly throughout the solution). The mixture was centrifuged and decanted through grade 4 Whatman filter paper to separate the MgSO₄ from the solution. The high dielectric polymer was left dissolved in the acetonitrile for further processing.

### Example 5: Preparation of Polydonor

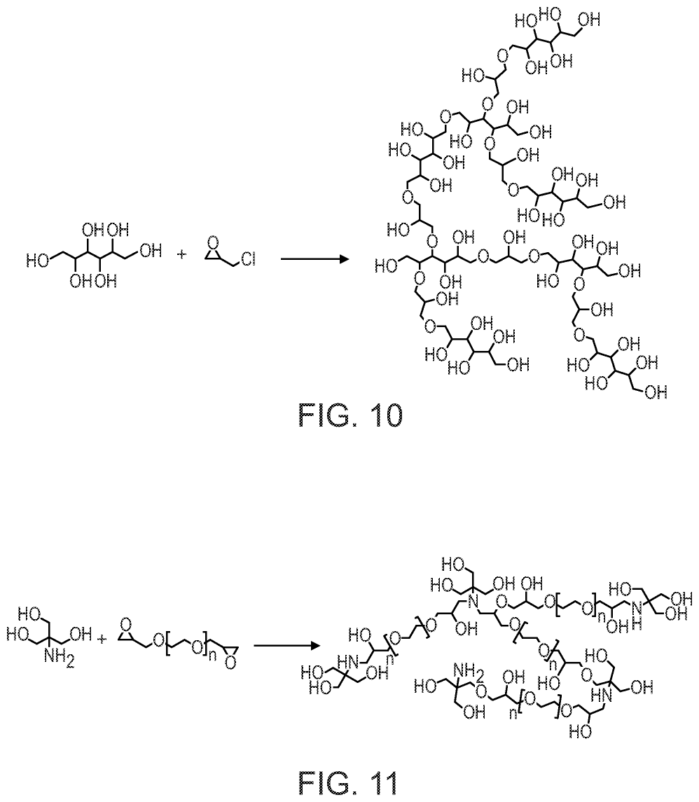

To a 250 mL round bottom flask, a magnetic stir bead was added along with 20.0 g of sorbitol (110 mmol), 20.0 g of deionized water, and 19.0 g of epichlorohydrin (205 mmol). The flask was capped with a silicone septum and placed in an oil bath with the temperature set to 60° C. Purging with inert gas was carried out as mentioned in Example 1. To a 40 mL septum vial, 28 g of potassium hydroxide solution (45 wt %) (225 mmol) was added. Following the same set up for the peristaltic pump as described in Example 1, potassium hydroxide was added at a rate of 5 rpm. Once all of the potassium hydroxide had been added, the solution was allow to mix overnight. After completion of the reaction, the solution was brought to neutral with 1M HCl and the solution was allowed to cool to room temperature. The solution was then transferred into dialysis tubing with a 1 k Da cut off and placed in a 1-gallon plastic jar filled with deionized water and a stir bar. The jar was placed on a stir plate and allowed to mix for 2 days, with the deionized water being replaced twice per day. After dialysis, the polymer solution was collected, and excess water was removed via rotary evaporation. The final product was 21 g of viscous clear polydonor. FIG. 10 illustrates the chemical reaction scheme to produce the polydonor of this example.

### Example 6: Preparation of Hyperbranched Polyglycerol as a Polydonor

For production of hyperbranched polyglycerol as a polydonor, lithium methoxide solution in methanol (2.2M) was transferred to a single-neck round bottom flask. Next, the round bottom flask was hooked to a rotary evaporation unit at 80° C. to remove methanol. After methanol had been removed, n-butanol (initiating monomer) was added to the flask and heated to 80° C. under nitrogen gas. The molar ratio of butanol to lithium methoxide was 10:1.

The flask was then connected to a nitrogen gas line and a bubbler outlet. The mixture was kept at 80° C. to allow time for methanol generated from reaction between the butanol and methoxide anion to exit through the bubbler. Next, 25 g of glycidol was injected to the round bottom flask, still under nitrogen gas, at 0.2 mL/min using a syringe pump. The reaction was allowed to proceed for 16 h under a nitrogen blanket before quenching by addition of 1 mL of deionized water.

Next, 20-50 mL of methanol was added to dilute the viscous polymer, followed by precipitation in 200 mL acetone. The polymer was collected by centrifugation, then washed with another 200 mL of acetone. The washed polymer was transferred to a 40 mL vial and hooked to the rotary evaporation unit with an oil bath temperature set at 80° C., and a vacuum was pulled and allowed to run overnight. Finally, the solvent free, viscous polymer was analyzed by nuclear magnetic resonance (NMR) to determine the molecular weight (MW) and degree of branching (DB).

### Example 7: Preparation of Polydonor

To a 500 mL round bottom flask, a magnetic stir bead was added. Next, 10.0 g (83 mmol) of tris(hydroxymethyl)aminomethane (tris), and 100.0 g of dimethylformamide (DMF) were added to the flask. Since tris contain a primary amine, it was not necessary to add cesium carbonate or other base catalyst to drive the reaction, since the amine acted as the base. The flask was then capped with a silicone septum stopper. The flask was place in an oil bath on a heated stir plate. A temperature probe was connected to the heated stir plate and submerged within the oil. The temperature was set to 100° C. and stirring was set to 600 rpm. Two stainless steel needles (20 gauge) were used to puncture the septum stopper. One of the needles was connected to a Schlenk line and used to purge the head space of the round bottom flask with nitrogen gas at a rate of 1 SCFH. The second needle acted as a relief, preventing pressure build up. The tris-DMF mixture was allowed to mix for 1 hour.

Meanwhile, to a 60 mL metered addition funnel, 36.6 g (82 mmol based on the epoxide number supplied in the COA) of polyethylene glycol diglycidyl ether (Mₙ=400) was added. The stopper attached to the flask containing the tris-DMF solution was then removed, and the addition funnel was connected, and the stopper was reconnected to the top of the addition funnel to continue purging with inert gas. The addition funnel was allowed to purge with inert gas for 15 minutes, then the metered stopcock was opened and the needle valve was adjusted until one drop of the crosslinker was added at every 6-10 seconds. The addition funnel was left open overnight, allowing the polyethylene glycol diglycidyl ether to be added dropwise over several hours. After approximately 20 hrs the heating and stirring were stopped. The silicone stopper and addition funnel were removed from the flask, and a PTFE sleeve was inserted. The flask was then connected to a rotary evaporator equipped with a bump trap and all the DMF was removed from the mixture. The product was a light brown viscous liquid. FIG. 11 illustrates the chemical reaction scheme to produce the polydonor of this example (“n” represents the number of repeat units in the PEG-diglycidyl ether crosslinker).

### Example 8: Preparation of Positive Electrode via Solvent-Based Method

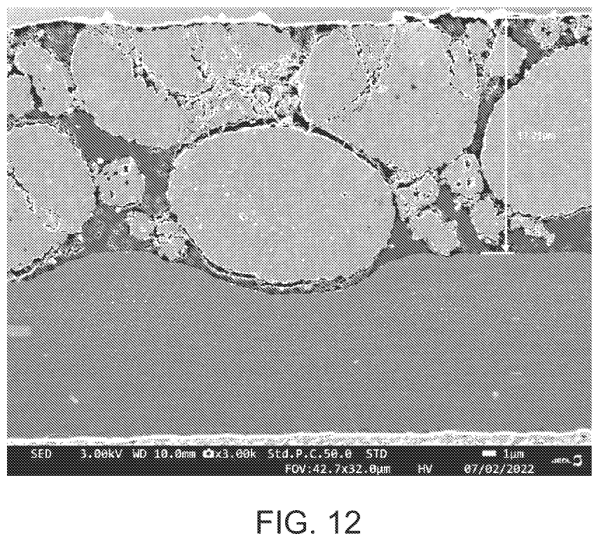

An electrode slurry was created using a FlackTek Speedmixer with a Max 20 cup. To the plastic cup, 1.57 g of N-methyl-2-pyrrolidone (NMP), and 0.63 g of solvent-free high dielectric polymer electrolyte containing 25 wt % of a lithium salt, such as Lithium bis(trifluoromethanesulfonyl)imide (LiTFSI) was added to act as the ionically conducting catholyte. The cup was then capped with a lid and mixed at 800 rpm for 15 seconds, 1200 rpm for 15 seconds, 1600 rpm for 15 seconds, 2000 rpm for 30 seconds, and 2750 rpm for 2 minutes. Then 0.50 g of electronically conductive carbon additive such as LITX200 (Cabot) was added and then mixed three times at 800 rpm for 15 seconds, 1200 rpm for 15 seconds, 1600 rpm for 15 seconds, 2200 rpm for 30 seconds, and 2750 rpm for 3 minutes. Then 8.98 g of a lithium containing cathode active material such as Lithium Nickel Cobalt Manganese Oxide (NCM811, POSCO N83MA11, D50 11.8 μm), 1.57 g of NMP, and 0.02 g of a premixed binder solution consisting of 20 wt % of Polyvinylidene Fluoride (PVDF, Arkema Kynar HSV1810) was added to the cup and then mixed twice at 800 rpm for 15 seconds, 1000 rpm for 15 seconds, 1400 rpm for 15 seconds, 1800 rpm for 30 seconds, and 2000 rpm for 5 minutes. Finally, 0.95 g of NMP was added and then mixed at 800 rpm for 15 seconds, 1000 rpm for 15 seconds, 1400 rpm for 15 seconds, 1800 rpm for 30 seconds, and 2000 rpm for 5 minutes. The resulting slurry was then cast onto carbon-coated aluminum foil (BlueNano, 17 μm) at the target loading using an adjustable doctor blade with a gap height setting of 60 μm. The coated foil was then dried in a forced convection oven (Yamato DNK402) at 100° C. for 16 hours to remove NMP and resulted in a dry composite electrode with a composition of 89.8 wt % NCM811, 5 wt % LITX200 carbon black, 5 wt % dielectric polymer electrolyte, and 0.3 wt % HSV1810 PVDF. The dried composite electrode was then densified using heated calender roll (TOB-JS-250L) at 55° C. to the reduce electrode porosity. The resultant electrode had a thickness of 20 μm and an areal loading of about 1.15 mAh/cm² assuming full utilization of the NCM811 (208 mAh/g). The completed electrode sheet was then punched to the correct dimensions and then an aluminum tab with pre-applied hot melt adhesive was ultrasonically welded (Branson MWX 100) onto the punched electrode tab region to create the complete cathode assembly. FIG. 12 shows a cross-section micrograph image of a composite cathode electrode (NCM811) containing the high dielectric polymer electrolyte described in Example 8. The electrode coating thickness was about 17 μm.

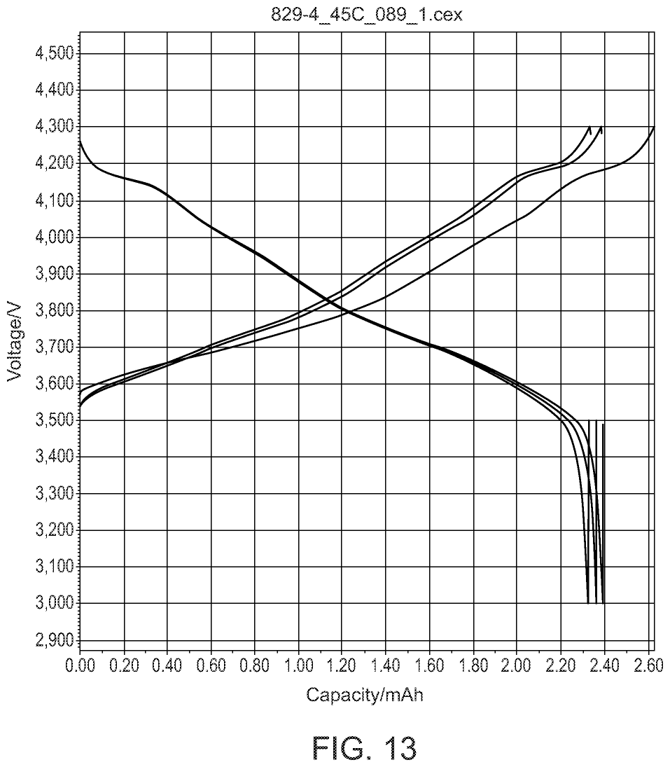

Electrochemical testing of the composite cathode containing catholyte was conducted using small factor pouch cells (2.526 cm²) consisting of a lithium anode (Honjo, 20 μm Li on 8 μm Cu), a ceramic filled separator (Entek, CF9), and a bulk electrolyte composed of a solvent-free high dielectric polymer electrolyte containing 60 wt % of Lithium bis(fluorosulfonyl)imide (LiFSI) and 10 wt % of diethyl carbonate (DEC) as an additive. The polymer electrolyte was applied to the CF9 separator as the cell as the cell was built to ensure complete wetting of the separator layer. The assembled stack was vacuum sealed at 100 kpa, clamped in a pressure fixture at 3 bar, and allowed to rest 6 hours at 45° C. before cycling. FIG. 13 illustrates exemplary cycling behavior of cathode half cells using NCM811 composite cathode electrodes as described in Example 8. Cycling was conducted between 3-4.3V using a constant current (CC) C-rate of 0.05 C to 4.3V and held at constant voltage (CV) until the current fell below 0.025 C. Constant current discharge was conducted at a 0.05 C rate until 3V. Cycling was done at 45° C.

### Example 9: Preparation of Positive Electrode via Solvent-Free Method

An electrode paste was created using a Resodyn Lab RAM I with a Max 10 cup. To the plastic cup, 0.29 g lithium salt such as Lithium bis(trifluoromethanesulfonyl)imide (LiTFSI), 0.20 g conductive carbon additive such as LITX200 (Cabot), 17.15 g lithium containing cathode active material such as Lithium Nickel Cobalt Manganese Oxide (NCM811, POSCO N83MA11, D50 11.8 μm), 1.59 g high dielectric polymer, and 0.78 g additive such as triethyl phosphate (TEP) were mixed using the LabRAM I acoustic mixer system. The accelerating force was ramped from 30 g to 70 g to ensure that the power level remained low and stable during mixing. Mixing time was about 12 minutes and was done in a manner to ensure that vessel temperature would reach and stabilized around 70° C. The resulting electrode paste was then applied to an appropriate current collector such as carbon-coated aluminum foil (BlueNano, 17 μm) followed by lamination of a Kapton film (a polyimide film) to act as the release liner. The stack was calendered using heated calender roll (TOB-JS-250L) at 70° C. to the flatten the applied paste to create an electrode with uniform thickness and low porosity. Reduction of thickness was down stepwise such that the gap was set to be about 10% smaller than the measured thickness and calendered several times before reducing the gap setting. This process was repeated several times until the target thickness and areal loading was achieved. To remove the release liner, the sample was cooled to <−40° C. in an environmental chamber (Test Equity, Model 115A-F) and the Kapton release liner was pulled at 180° in the opposite direction such that it was parallel the surface to help ensure a clean release. These electrodes where then punched to the correct dimensions and then an aluminum tab with pre-applied hot melt adhesive was ultrasonically welded (Branson MWX 100) onto the punched electrode tab region to create the complete cathode assembly.

### Comparative Testing

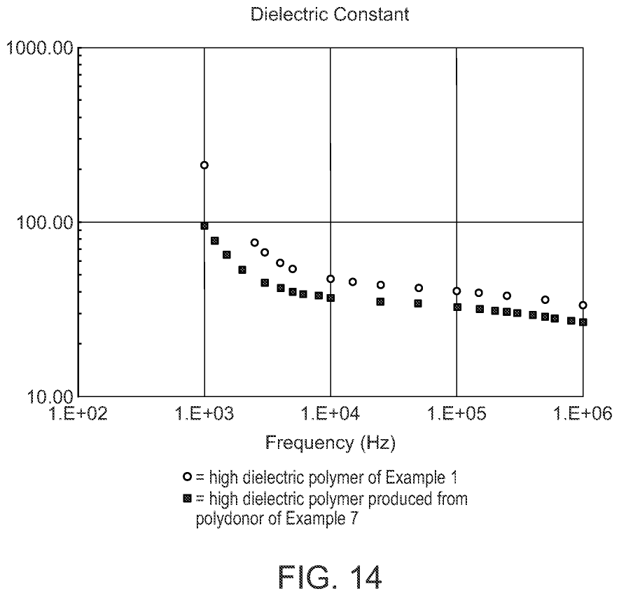

Dielectric permittivity as a function of frequency was measured for two different high dielectric polymers. FIG. 14 illustrates the testing data for the high dielectric polymer of Example 1 (dielectric permittivity of approximately 33 at 1 MHz) and the testing data for the high dielectric polymer produced from the polydonor described in example 7 (acrylonitrile was used as a Michael acceptor, and the measured dielectric permittivity was approximately 26 at 1 MHz).

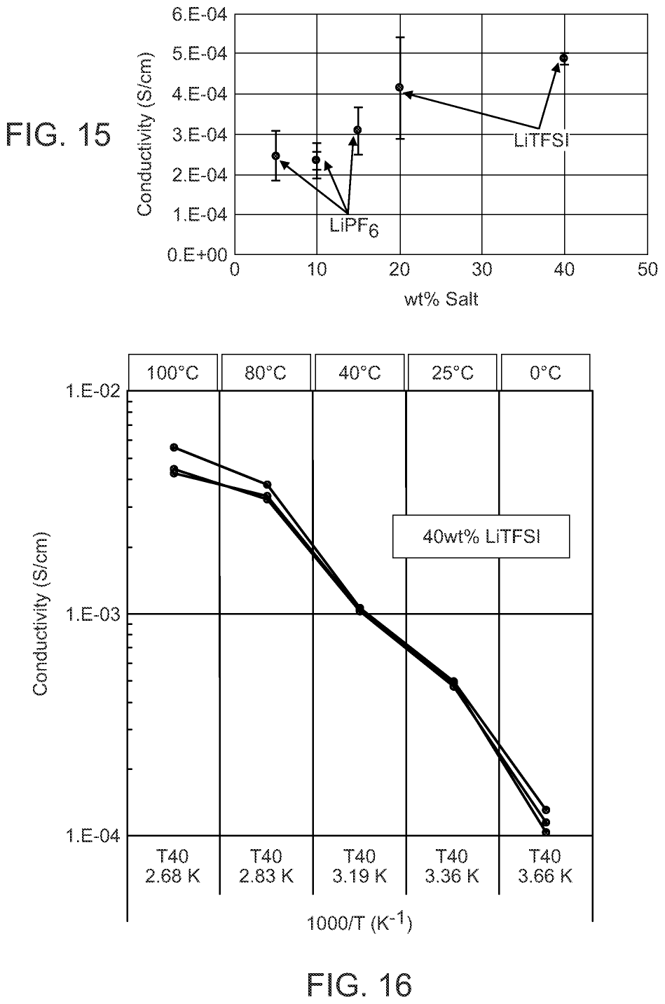

Ionic conductivity as a function of salt concentration, for two different salts, of polymer electrolytes produced from the polymer described in Example 1 was measured. The results are shown in FIG. 15. Error bars represent the standard deviation of 3 different conductivity cells. The peak conductivity is seen for 40 wt % LiTFSI, at ˜0.5 mS/cm.

The conductivity of the high dielectric polymer described in Example 1, when made into a polymer electrolyte containing 40 wt % LiTFSI, was measured. The resulting measurements are shown in FIG. 16.

While the subject technology has been described with respect to certain particular embodiments, those skilled in the art will readily appreciate that various changes and/or modifications may be made to the subject technology by those of ordinary skill in the art without departing from the inventive nature of this disclosure. Furthermore, it is to be understood that the presently disclosed concepts are intended to be covered by the following claims unless these claims by their language expressly state otherwise.

What is claimed is:

1. A method of producing a high dielectric polymer, the method comprising:
reacting a starting material containing at least three nucleophilic sites with a crosslinker to produce a polydonor, wherein the polydonor is a branched polymer containing a plurality of reactive nucleophilic sites;
functionalizing the plurality of reactive nucleophilic sites of the polydonor to produce a high dielectric polymer; and
purifying the high dielectric polymer.

2. The method of claim 1, wherein the starting material is selected from the group consisting of a polyalcohol (polyol), sorbitol, pentaerythritol, inositol, pentaerythritol, dipentaerythritol, an aminoalcohol, tris(hydroxymethyl)aminomethane, 2-Amino-2-methyl-1-propanol, 2-Amino-2-methyl-1,3-propanediol, cysteine, dithiothreitol, other thiols, and/or polyethyleneimine.

3. The method of claim 1, wherein the starting material is a Michael donor.

4. The method of claim 1, wherein the plurality of nucleophilic sites comprise —OH, —NH₂, and/or —SH groups.

5. The method of claim 1, wherein the crosslinker is a difunctional crosslinker.

6. The method of claim 1, wherein the crosslinker is a diglycidyl ether, a dichloride, a dibromide, a diisocyanate, epichlorohydrin, a diacrylate, a divinyl, and/or a dialdehyde.

7. The method of claim 6, wherein the crosslinker is selected from the group consisting of divinyl sulfone, glycerol diglycidyl ether, PEG-diglycidyl ether, and epichlorohydrin.

8. The method of claim 1, further comprising purifying the polydonor.

9. The method of claim 1, wherein functionalizing the plurality of reactive nucleophilic sites is accomplished by nucleophilic addition.

10. The method of claim 1, wherein functionalizing the plurality of reactive nucleophilic sites is accomplished by Michael addition.

11. The method of claim 1, further comprising combining the high dielectric polymer with an electrochemically active material to form a polymer electrolyte.

12. The method of claim 11, further comprising incorporating the polymer electrolyte into a lithium-ion battery as an anolyte or a catholyte.

13. An electrochemical cell comprising:
an anode comprising a first electrochemically active material;
a cathode comprising a second electrochemically active material;
a first electrolyte positioned within either the anode or the cathode; and
a second electrolyte interposed between the anode and the cathode;
wherein at least one of the first electrolyte and the second electrolyte comprises a high dielectric polymer having dielectric permittivity greater than 10 and a glass transition temperature less than −30° C.

14. The electrochemical cell of claim 13, wherein the dielectric permittivity of the high dielectric polymer is greater than 20 and the glass transition temperature is less than −70° C.

15. The electrochemical cell of claim 13, wherein the second electrochemically active material comprises lithium ions.

16. The electrochemical cell of claim 15, wherein the first electrolyte comprises the high dielectric polymer.

17. A high dielectric polymer comprising a branched and functionalized polymer backbone, wherein the high dielectric polymer has a dielectric permittivity greater than 10 and a glass transition temperature less than −30° C.

18. The high dielectric polymer of claim 17, wherein the high dielectric polymer is produced by functionalizing a plurality of nucleophilic sites of a polydonor.

19. An electrochemical cell comprising a polymer electrolyte containing the high dielectric polymer of claim 17.

20. The electrochemical cell of claim 19, wherein the electrochemical cell is a lithium-ion battery.
